(19) United States
(12) Patent Application Publication
(10) Pub. No.: US 2004/0096568 A1
(43) Pub. Date: May 20, 2004

(54) Process for the production of foodstuff smoke by pyrolysis, use of a reactor particularly adapted to said process, smoke and smoked foodstuffs thus obtained

(75) Inventors: Pierre Holzschuh, Kehl (DE); Georg Buch, Schutterwald (DE); Jean-Jacques Weiland, Hattmatt (FR)

Correspondence Address: YOUNG & THOMPSON, 745 SOUTH 23RD STREET 2ND FLOOR, ARLINGTON, VA, 22202

(73) Assignee: SOFRAL SOCIETE FRANCAISE D'ALIMENTATION S.A., ILLKIRCH GRAFFENSTADEN (FR)

(21) Appl. No.: 10/612,972

(22) Filed: Jul. 7, 2003

Related U.S. Application Data
(60) Provisional application No. 60/396,015, filed on Jul. 16, 2002.

(30) Foreign Application Priority Data
Jul. 5, 2002 (FR) 02 08495

(51) Int. Cl. A23L 1/221

(52) U.S. Cl. 426/650

(57) ABSTRACT

The present invention relates to the field of the production of smoke for food processing usage and has for its object a process characterized in that it comprises essentially the steps consisting in introducing the organic material to be pyrolyzed into a reactor comprising essentially a heatable chamber that is substantially sealed, containing at least one ascending tubular element that is vibrated and receiving said material, at the level of the lower portion of said tubular element, heating said organic material to a temperature comprised between 200° C. and 800° C., preferably between 300° C. and 400° C., so as to cause pyrolysis during its movement, under the influence of vibrations, in the ascending tubular element or elements, and extracting the consumed material and the produced smoke at the level of the upper portion of said tubular element or elements.

The present invention relates to the field of food processing and more particularly to the production of food flavors by pyrolysis of vegetable organic materials. It relates more particularly to the production of smoke, in particular liquid smoke, with the help of a process using a pyrolysis reactor of the electrically vibrated elevating reactor type.

Smoking is, with seasoning, one of the oldest techniques for preserving foodstuffs. Thus, it was invented not long after the discovery of fire by humans. At the outset, the object was to increase the preservation time of the treated product. Later, it was principally the search for taste properties and incidentally that of preserving the product, which prevailed.

Old products have been used until the last century but thereafter, the techniques have been modernized and diversified, the conventional smoking methods now representing only a small volume of the worldwide magnitude.

Thus, new products have for example been discovered in the United States during the XIXth century. These products, also called liquid smoke or liquid smoke compositions, have been developed so as to replace the direct contact of the foodstuff with smoke and are obtained by condensing gaseous smoke obtained by pyrolysis of a vegetable organic material, most often wood, in liquid form.

It is thus known that the pyrolysis of vegetable materials, in particular the pyrolysis of wood particles or chips, leads to the formation of aromatic molecules during processes of thermal decomposition of said vegetable material. The chemical nature of the flavors obtained depends essentially on the processing parameters, such as the temperature of pyrolysis, the dwell time or else the gaseous atmosphere used in the course of the pyrolysis reaction.

Moreover, the principal part of the chemical compounds constituting the smoke obtained during pyrolysis is liquid at ambient temperature. Because of multiple advantages, these products have tended to constitute more and more the new production standards of smoked foodstuffs. Thus liquid smokes are particularly used preferably during smoking of ham, sausage, fish, bacon, etc., a smoked flavor as well as a typical brown coloration, similar to those observed during conventional smoking, being thus obtained.

The liquid smokes constitute complex mixtures that can comprise more than 1,000 different chemical compounds, of which 400 have been clearly identified. These compounds generally belong to chemical families whose principals are carboxylic acid, carbonyls, phenols and polycyclic aromatic hydrocarbons.

By way of example of a typical composition of liquid smoke, can be cited U.S. Pat. No. 3,106,473.

Generally speaking, it is known that organic acids have an action on the preservability of smoked foodstuffs and that the carbonyl compounds are the source of the color of smoked products. However, because of the extreme chemical complexity of liquid smoke, synergies between the different chemical compounds are more than probable.

A certain number of undesirable compounds are also produced during pyrolysis processes. Polycyclic aromatic hydrocarbons (PAH) are toxic compounds produced during pyrolysis at high temperature of organic materials. These compounds must be eliminated from the liquid smoke or their content must at least be minimized. Present standards in force in Europe impose a maximum quantity of 10 ppb of benzo[a]pyrene and 20 ppb of benzoanthracene in liquid smoke.

The control of the quantity of polycyclic aromatic hydrocarbons in liquid smoke thus permits minimizing the health risks relative to the conventional smoking methods.

For the production of aromatic smokes, various pyrolysis reactors have been developed in the course of recent decades.

In a first type of reactor described in U.S. Pat. No. 4,298,435, pyrolysis can be carried out in a rotating oven inclined at an angle of 5°. Such an oven is constituted by a rotating calciner comprising a stainless steel tube that can be brought to the desired temperature. The wood enters the tube at a temperature of 480° C. such that the only oxygen is in the air entrained by the sawdust at the time of loading.

In a second type of reactor described in U.S. Pat. No. 3,875,314, pyrolysis is carried out with the help of a conveyor which passes through a chamber in which prevails a temperature comprised between 600° C. and 750° C.

In a third type of reactor described in U.S. Pat. No. 4,994,297, an ultra-rapid so-called “flash” pyrolysis (speed of temperature increase of 1000° C./s) permits producing liquid smoke having a carbonyl/phenol ratio greater than the smoke obtained by conventional methods. The smoke which is produced by this type of reactor has a more pronounced coloring power but imparts a less intense smoked flavor to the treated food products. The output in pyrolignous juice is very interesting, because it is much higher than that obtained by conventional pyrolysis. The sawdust or cellulose is heated between 450° C. and 650° C. in one second. The dwell time of the gases emitted is 0.03 second to 2 seconds in the reactor, then the gases are evacuated (in less than 0.6 second) to cool them to 350° C.

In a fourth type of reactor described in U.S. Pat. No. 4,883,676, the pyrolysis is carried out by ensuring a sweeping of dry air at high temperature over a fine layer (2 cm at most) of dry sawdust. The output thus reaches 90% instead of 45 to 50% by conventional methods. The gas produced is very rich in condensable compounds and residue is produced, said sweeping limiting the secondary reactions which are precisely the original of the formation of residue. In batch-wise operation, the pyrolysis temperature should be 600° C., whilst when operating semi-continuously, the optimum pyrolysis temperature is only 290° C.

The pyrolysis of the wood can also be carried out under water vapor as described in U.S. Pat. No. 4,359,481, the pyrolysis temperature then being 400° C.

However, must of these installations and processes do not permit strict control of the pyrolysis temperature or the dwell time.

Another process has been described in French patent FR 2 680 638 B1 relating to roasting of products uniquely of food processing (malt, cocoa, coffee, nuts, etc.).

German patent application DE 35 04 950 A1 relates also to roasting coffee in a vibrating helicoidal reactor. However, nothing in these last two publications indicates or suggests that such reactors would be adapted to the production of foodstuff smoke, in particular the production of liquid smoke, the object of these processes being above all to recover a roasted foodstuff.

The present invention has for its object to overcome at least certain of the mentioned drawbacks.

To this end, it has for its object a process which involves destructive distillation or a thermal modification of vegetable substances, particularly wood.

According to the present invention, the process for the production of smoke used for the smoking of foodstuffs, said smoke being obtained by pyrolysis of an organic material, preferably vegetable, is characterized in that it comprises essentially the steps consisting in:

introducing said organic material to be pyrolyzed into a pyrolysis reactor comprising essentially a heatable chamber that is substantially sealed, containing at least one ascending tubular element that is vibrated and receiving said organic material, said material being introduced at the level of the lower portion of said tubular element,

heating said organic material in said chamber to a temperature comprised between 200° C. and 800° C., preferably between 300° C. and 400° C., so as to produce pyrolysis during its movement, under the effect of vibrations, in the ascending tubular element or elements and,

extracting the consumed organic material and the produced smoke at the level of the upper portion of said tubular element or elements.

The present invention also has for its object the use of a vibrated elevating reactor of the type comprising essentially a heatable chamber that is substantially sealed, containing at least one ascending tubular element that is vibrated and receiving an organic material to be pyrolyzed, for the production of smoke adapted for smoking foodstuffs, for the production of liquid smoke and for the production of wood charcoal.

It also has for its object the smoke adapted for smoking foodstuffs obtained by the process according to the invention, characterized in that it has a content by volume of benzo[a]pyrene of 10 μg/m³ and 20 μg/m³ by volume of benzoanthracene, or, once condensed as liquid smoke, a content by volume of benzo[a]pyrene of at most 10 ppb and a content by volume of benzoanthracene of at most 20 ppb, as well as the liquid smoke obtained by condensation of said smoke.

Finally, it also has for its object a foodstuff smoked by the use of a smoke or a liquid smoke according to the invention.

The invention will be better understood from the description which follows, which relates to a preferred embodiment, given by way of non-limiting example.

The object of the process according to the present invention is to produce smoke by pyrolysis of an organic material, preferably by the pyrolysis of particles of wood or vegetable material. Preferably, the smoke can be condensed in liquid form so as to produce products also called “liquid smoke”.

According to the invention, the process for the production of smoke adapted for smoking food products, said smoke being obtained by pyrolysis of an organic material, preferably vegetable, is characterized in that it comprises essentially the steps consisting in:

introducing said organic material to be pyrolyzed into a pyrolysis reactor comprising essentially a heatable chamber substantially sealed, containing at least one ascending tubular element that is vibrated, and receiving said organic material, said material being introduced at the level of the lower portion of said tubular element,

heating said organic material in said chamber to a temperature comprised between 200° C. and 800° C., preferably between 300° C. and 400° C., so as to give rise to pyrolysis during its movement, under the effect of vibrations, in the ascending tubular element or elements and,

extracting consumed organic material and the produced smoke at the level of the upper portion of said tubular element or elements.

Preferably, the tubular element or elements are given a vibratory movement having a horizontal and/or vertical component.

In a particularly useful modification, the process according to the present invention is characterized in that the organic material is dried by preheating before being pyrolyzed, preferably in at least one specific preheating zone provided in the tubular element or elements and more preferably by electrical heating of said zone or zones by the Joule effect.

Thus, it becomes possible to treat any type of organic material in the same device. The temperature and time of preheating and the quantity of residual moisture can be determined by those skilled in the art according to the nature and quality of the organic material used. However, care should preferably be taken not to provoke pyrolysis during said preliminary drying operation. In other words, the preheating temperature of the organic material is preferably lower than the pyrolysis temperature of said material, namely preferably lower than 200° C.

According to another characteristic, the heating of the organic material for its pyrolysis takes place by direct heating of the tubular element or elements, preferably by electrical heating by the Joule effect.

The electrically vibrated elevating reactor permits a continuous thermal treatment of the vegetable material with strict control of the treatment parameters. The possibilities of treatment of the electrically vibrated elevating reactor permit producing smoke, liquid smoke, thermally modified woodchips, as well as wood charcoal.

The present invention thus permits a perfectly controlled pyrolysis of the vegetable material.

The liquid smoke thus obtained can be used by spraying an air-smoke distillate mixture directly into the smoking chamber, by quenching, irrigating or else by direct addition to the foodstuff. The smoke contains neither residues nor noxious polycyclic aromatic hydrocarbons. The smoke thus produced corresponds to all of the aromatic fraction from the pyrolysis of the wood obtained by conventional processes.

A reactor of the EVER (electrically vibrated elevating reactor) type that is particularly well adapted to the process according to the invention is that sold by the REVTECH company (Charmes sur Rhône), which is the object of French patent 91 10 935 published under the number FR 2 680 638 A1, the disclosure of which is incorporated herein by reference.

A similar oven to that described in this patent, in German patent DE 35 04 950 or any other type of suitable vibrated oven, independently of the source of heat used to trigger the pyrolysis reaction properly so-called, will also be suitable as pyrolysis reactors usable in the scope of the process of the present invention and this latter is thus not limited to these two examples of particular devices.

Such a type of reactor of the EVER type preferably combines the technology of transporting particles by vibration and the technology of the tube through which they flow, and thus permits access to developed techniques of thermal treatment of divided solids. This reactor thus permits the continuous thermal treatment of the organic material to be pyrolyzed.

The transport of the organic material to be pyrolyzed is ensured by vibration according to the principle of elevating spirals. The organic material to be pyrolyzed is introduced in a conventional manner (manual feed or automatic, hopper . . . ) at one of the ends (preferably the lower end) of the tubular element or elements and moves under the influence of vibrations imparted to said tubes, to the other end (preferably the upper end) where it is recovered in a manner that is also conventional (recovery bin or the like). The vibrations may for example be generated by a vibrating table moved by an electric motor capable of transmitting to said table vibratory movements in a horizontal plane, for example in rotation, and vibrations in a vertical direction. To this end, the vibrations can be generated in known manner by motors with eccentric weights or any other equivalent device.

The tubular element or elements pass through a fixed chamber which permits heating and elevating the temperature of said tubular element or elements either directly or indirectly. By way of preferred example, the passage of an electric current through the transport tube permits generating the heat by the Joule effect throughout the mass of the tube.

The tubular element or elements can be constituted by a completely closed stainless steel coil. The treatment atmosphere can thus be strictly controlled. The treatment of the organic material can thus be carried out under an inert gas (nitrogen or any other inert gas), under a partially oxidizing gas (nitrogen/oxygen mixture at different concentrations of oxygen) or else under carbon dioxide or under a recycling of the produced smoke (recycling of the pyrolysis gases during thermal treatment).

In a particularly preferred manner, the process of the invention is thus characterized in that the smoke produced is condensed at the outlet of the reactor in a suitable condensation device.

Preferably, at least one portion of the pyrolysis gas present at the outlet of the condensation device is re-injected into the reactor.

According to another characteristic, the process according to the invention is also characterized in that the pyrolysis takes place under precise control, of about 0.1%, of the volume content of oxygen in said reactor and according to another characteristic the pyrolysis takes place under precise control, to about one degree Celsius, of the temperature prevailing in said reactor.

Thus, the control of these latter parameters permits preferably reducing the risk of fire in the installation, contrary to most of the existing smoke generators.

The dwell time of the organic material to be pyrolyzed can also be fixed in a precise manner. Thus, the technology of the vibrating tube permits a “piston” flow of the material to be treated. Thus, the inclination of the motors with eccentric weights as well as the frequency and amplitude of vibrations, permit controlling the dwell time of said material in the reactor. This dwell time can vary, according to conditions, from several seconds to about 30 minutes.

The technology of transport by vibrating tube permits treating divided solids with a large granulometry, permitting using a wide range extending from micrometric powders to pieces of several centimeters of organic material.

Preferably, the pyrolyzed organic material is essentially constituted by woodchips, in particular wood adapted for the flavoring or aging of wines and/or spirits.

According to one modification, the pyrolyzed organic material is essentially constituted by fibers or chips of at least one vegetable substance such as wood, cellulose, any other polysaccharide or complex ligno-cellulose.

As explained, the pyrolysis temperature (from 200° C. to 800° C.) as well as the temperature profiles are perfectly controlled to about one degree. The possibility of an electric architecture permitting using several independent heating zones permits, as the case may be, controlling the thermal processing profile of the vegetable material. The provision of a cooling zone, by use of several unheated spirals or by a double envelope containing a cooling fluid, permits obtaining low and constant temperatures of the pyrolyzed material at the outlet of the reactor.

The thermal decomposition of the organic material and particularly of the wood is preferably obtained at low pyrolysis temperatures with the help of reactors of the EVER type (principally between 300° C. and 400° C.). The smoke and liquid smoke thus contain little polycyclic aromatic hydrocarbons, which are generally formed at high pyrolysis temperatures (above 400° C.).

The present invention also has for its object the use of a vibrating elevating reactor of the type comprising essentially a heatable chamber that is substantially sealed, containing at least one ascending tubular element that is vibrated and receiving an organic material to be pyrolyzed, for the production of smoke adapted for smoking foodstuff, for the production of liquid smoke as well as for the production of wood charcoal.

The advantages of the use of a reactor of the EVER type for the thermal treatment of vegetable materials are many:

A homogeneous thermal treatment of organic material of variable granulometry (for example wood sawdust of several microns to several centimeters) is possible by the “piston” advance of the material in the reactor and by intimate contact between the vegetable material and the hot tube. The “piston” flow permits controlling with precision the temperature of the material and the dwell time.

Heating is ensured by conduction between the tube and the vegetable material. The process does not require the use of large quantities of gases to be controlled or cleansed. The risk of cold regions (soot traps) are minimized.

The sealing of the system, without mechanical members, permits minimizing the risk of emitted smells and exposure of personnel to the pyrolysis gases.

The cleaning of the installation is easy by pyrolysis in air, by circulation of cleaning liquid in the coils or else by a scraper body.

The thermal output of the apparatus is about 80% by intimate contact between the vegetable material and the hot transport tube as well as a complex combination of conduction, induction and radiation toward the product to be heated.

The transport by vibrating tube gives rise to no abrasion of the organic material to be pyrolyzed and limits the emissions of charcoal dust. Clogging of the reactor by soot deposits is minimal.

Accordingly, reactors of the type described above can be advantageously employed for the production of smoke. Thus, the process using vibrating tubular elements permits producing smoke whose quality and concentration are perfectly controlled whilst minimizing the risks of fire.

In this connection, it is particularly important to be able to control, in a process using such a reactor, the principal parameters of operation and processing which are the pyrolysis temperature (controlled to about one degree Celcius) and the chemical constitution of the treatment atmosphere (precise control of the concentration of oxygen). Under these conditions, the smoke produced by the process according to the invention can be totally standardized and is desirably free or almost free from residue and noxious polycyclic aromatic hydrocarbons.

The present invention thus also has for its object smokes adapted for the smoking of foodstuffs, obtained by the process according to the invention, characterized in that they have, once condensed as liquid smoke, a volume content of benzo[a]pyrene of at most 10 ppb and a volume content of benzoanthracene of at most 20 ppb.

Moreover, said smoke can be diluted with hot air or another gas at the outlet of the reactor so as to produce more or less concentrated smoke. It can also directly enter into a smoking compartment, without other steps of treatment or purification.

The present invention also has for its object liquid smokes obtained by concentration of smoke according to the invention as well as a foodstuff smoked by the use of such smoke.

The following examples which are not limiting, permit showing certain advantages of the objects of the present invention.

### EXAMPLE 1

Moist birch sawdust (35% moisture) is pyrolyzed in a reactor of the EVER type (REVTECH company). The reactor has two heating zones. The first zone is heated to a temperature of 190° C. whilst the second heating zone is at a temperature of 340° C. The gas emitted from the first heating zone is evacuated to the outside following dilution with dry air. The second heating zone is swept by a neutral gas. The sawdust undergoes drying in the first zone and enters into the second heating zone with a moisture content less than 1% by weight.

The pyrolysis of the sawdust is carried out entirely in the second zone where the vegetable material is brought to 340° C., then it is rapidly cooled in the cooling coils to 40° C.

The emitted gas is evacuated with the countercurrent injected nitrogen, to an indirect condenser. The condensable organic compounds are recovered in the form of liquid at the outlet of the condenser.

This arrangement of reactor described in Example 1 permits continuous simultaneous drying and pyrolysis of the moist beech sawdust. The obtained condensates form a concentrated liquid smoke. Thus, the initial moisture of the sawdust is evacuated to outside the reactor before the sawdust enters the pyrolysis zone.

The liquid smoke obtained has the following characteristics:

| Density: | 1.11 kg/l |
|---|---|
| pH: | 1.8 |

Gas phase chromatographic analysis (% by weight):

| acetic acid: | 15% | |
|---|---|---|
| carbonyls: | 8% | |
| esters: | 4 | mg/ml |
| furans: | 15 | mg/ml |
| lactones: | 4 | mg/ml |
| phenols: | 32 | mg/ml |

### EXAMPLE 2

Dry birch sawdust (7% by weight moisture) is pyrolyzed in a reactor of the EVER type (REVTECH company). The reactor has a single heating zone. The heating zone is brought to a temperature of 320° C., 330° C., 340° C. then 350° C.

The temperatures measured in the organic material are respectively 320° C., 330° C., 340° C. and 350° C. Example 2 shows perfectly the temperature control during the pyrolysis process of the organic material to be pyrolyzed. No phenomenon of divergence in temperature is observed despite the existence of exothermic phenomena at such pyrolysis temperatures, for example in the case of wood. The reactor of the EVER type permits thermal treatment that is perfectly controlled as to temperature and as to dwell time, in particular for wood sawdust, contrary to the existing smoke generators.

### EXAMPLE 3

Dry birch sawdust (7% by weight moisture) is pyrolyzed in a reactor of the EVER type (REVTECH company). The reactor has a single heating zone. The heating zone is at a temperature of 350° C. The condensable and incondensable gases are brought to a condenser. The condensable portion of the pyrolysis gas is recovered in the form of liquid at the outlet of the condenser, whilst the incondensable gases (essentially carbon dioxide) are used to render the pyrolysis zone inert.

The “recirculation” of the incondensable gases permits very rapidly and effectively rendering inert the pyrolysis zone and permits avoiding the external supply of neutral gas. The output of conversion of the first material in liquid smoke is 35%. In addition to the high conversion output, the smoke obtained contains no residue. The composition of the liquid smoke obtained after condensation is as follows:

| Density: | 1.11 kg/l |
|---|---|
| pH: | 1.8 |

Gas phase chromatographic analysis (% by weight):

| acetic acid: | 17% | |
|---|---|---|
| carbonyls: | 10% | |
| esters: | 2 | mg/ml |
| furans: | 20 | mg/ml |
| lactones: | 0.5 | mg/ml |
| phenols: | 45 | mg/ml |

The use of the process according to the present invention thus permits producing smoke with a high output and without the production of residue, contrary to the reactors and smoke generators at present on the market.

The liquid smoke obtained according to the invention is rich in aromatic compounds (phenols) and in carbonyls. These latter are the source of particularly effective and realistic coloration of products smoked with smoke according to the invention, due to the Maillard reactions with the proteins contained in said treated foodstuffs.

The indirect condensation of the smoke permits recovering all of the flavors and hence all of the aromatic fraction contained in the smoke. Tests carried out on pork products by dosing with this liquid smoke, give a particularly fine smoked flavor, identical to or even greater than that used when smoking with conventional processes.

The present invention thus also has for its object a foodstuff smoked by the use of smoke and/or liquid smoke according to the invention.

The EVER type reactor constitutes a very useful tool for treatment of vegetable material. In addition to the application connected with the production of smoke for the smoking of foodstuffs or liquid smoke, the EVER reactor can also be used advantageously during the thermal treatment of comminuted vegetable materials. For example, the EVER reactor can be used for the production of woodchips adapted for flavoring or aging of wines and spirits; the aromatic compounds sought being similar to those found in liquid smoke.

The process according to the invention is also suitable for the production of wood charcoal or thermally modified vegetable loads that can be incorporated in plastic base composites or hydraulic binders.

Of course, the invention is not limited to the described embodiment. Modifications remain possible, particularly as to the construction of the various elements or by substitution of technical equivalents, without thereby departing from the scope of protection of the invention.

1. Process for the production of smoke adapted for smoking foodstuffs, said smoke being obtained by pyrolysis of an organic material, preferably vegetable, characterized in that it comprises essentially the steps consisting in:
introducing said organic material to be pyrolyzed into a pyrolysis reactor comprising essentially a heatable chamber substantially sealed, containing at least one ascending tubular element that is vibrated and receiving said organic material, said material being introduced at the level of the lower portion of said tubular element,
heating said organic material by direct heating of the tubular element or elements, preferably by electrical heating by the Joule effect, in said chamber at a temperature comprised between 200° C. and 800° C., preferably between 300° C. and 400° C., so as to produce pyrolysis during its movement, under the effect of vibrations, in the ascending tubular element or elements, and
extracting the consumed organic material and the produced smoke at the level of the upper portion of said tubular element or elements.

2. Process according to claim 1, characterized in that the tubular element or elements are given a vibratory movement having a horizontal and/or vertical component.

3. Process according to claim 1 or 2, characterized in that the organic material is dried by preheating before it being pyrolyzed, preferably in at least one specific preheating zone provided in the tubular element or elements and more preferably by electrical heating of said zone or zones by the Joule effect.

4. Process according to any one of claims 1 to 3, characterized in that the smoke produced is condensed at the outlet of the reactor in a suitable condensation device.

5. Process according to any one of claims 1 to 4, characterized in that at least one portion of the pyrolysis gas present at the outlet of the condensation device is re-injected into the reactor.

6. Process according to any one of claims 1 to 5, characterized in that pyrolysis takes place under strict control, to about 0.1%, of the volume content of oxygen in said reactor.

7. Process according to any one of claims 1 to 6, characterized in that pyrolysis takes place under precise control, to about one degree Celcius, of the temperature prevailing in said reactor.

8. Process according to any one of claims 1 to 7, characterized in that the pyrolyzed organic material is essentially constituted by woodchips, in particular wood suitable for flavoring or aging of wine and/or spirits.

9. Process according to any one of claims 1 to 7, characterized in that the pyrolyzed organic material is essentially constituted by fibers or chips of at least one vegetable substance such as wood, cellulose, any other polysaccharide or complex ligno-cellulose.

10. The use of a vibrated elevating reactor for the practice of the process according to the invention of claims 1 to 9, of the type comprising essentially a heatable chamber substantially sealed, containing at least one ascending tubular element that is vibrated and receiving an organic material to be pyrolyzed, for the production of smoke adapted for smoking foodstuffs.

11. Use according to claim 10, for the production of liquid smoke.

12. Use according to claim 10, for the production of wood charcoal.

13. Smoke adapted for smoking foodstuffs obtained by the process according to any one of claims 1 to 9, characterized in that it has, once condensed into liquid smoke, a volume content of benzo[a]pyrene of at most 10 ppb and a volume content of benzoanthracene of at most 20 ppb.

14. Liquid smoke obtained by condensation of smoke according to claim 13.

15. Foodstuff smoked by the use of smoke according to claim 13 and/or a liquid smoke according to claim 14.
